(19) United States
(12) Patent Application Publication
(10) Pub. No.: US 2021/0002180 A1
(43) Pub. Date: Jan. 7, 2021

(54) Concrete Wet Cast Ready Mix Composition

(71) Applicant: Buffalo Beginnings, LLC, Herron, MI (US)

(72) Inventors: Anthony Gauci, Wallarah (AU); Michael R. Meyer, Herron, MI (US)

(21) Appl. No.: 17/029,110

(22) Filed: Sep. 23, 2020

Related U.S. Application Data
(63) Continuation-in-part of application No. 15/860,729, filed on Jan. 3, 2018.
Application No. 15/860,729 is a continuation-in-part of application No. 14/862,493, filed on Sep. 23, 2015, now abandoned.

(51) Int. Cl. C04B 40/00; C04B 14/22; C04B 28/02

(52) U.S. Cl. CPC C04B 40/0039; C04B 2111/00017; C04B 28/02; C04B 14/22

(57) ABSTRACT

A concrete block wet cast ready mix composition preferably includes ground recycled glass, river sand, river gravel, cement, soap, water and a water proofing substance. The river gravel preferably includes natural stone, granite, limestone and domite. The cement is preferably an off white cement. The soap is preferably laundry detergent. The water proofing substance is preferably Grace Optec Admix waterproofing. The wet cast composition is preferably mixed in the following manner. The ground recycled glass, the river sand and the river gravel are mixed together to form an aggregate mix. The cement is combined with the aggregate mix to form a cement aggregate mix. Water is added to the cement aggregate mix to form a wet aggregate mix. Finally, the soap and the waterproofing substance are combined with the wet aggregate mix. The wet cast composition is now ready to be poured into concrete block molds or poured as cast concrete.

### CROSS-REFERENCES TO RELATED APPLICATIONS

This continuation in part patent application takes priority from patent application Ser. No. 15/860,729, filed on Jan. 3, 2018, which takes priority from patent application Ser. No. 14/862,493, filed on Sep. 23, 2015.

### BACKGROUND OF THE INVENTION

### Field of the Invention

The present invention relates generally to masonry and more specifically to a concrete wet cast ready mix composition, which is hydrophobic.

### Discussion of the Prior Art

It appears that the prior art does not disclose a concrete wet cast ready mix composition, which is hydrophobic and also provides vibrant color when a colorant is mixed therein.

Accordingly, there is a clearly felt need in the art for a concrete wet cast ready mix composition, which is hydrophobic and has the unexpected result of allowing a higher percentage of recycled glass to be used in the wet cast ready mix composition and providing a more vibrant color than that of the prior art when a colorant is added to the mixture.

### SUMMARY OF THE INVENTION

The present invention provides a concrete wet cast ready mix composition, which is hydrophobic. The concrete wet cast ready mix composition (wet cast composition) preferably includes ground recycled glass, river sand, river gravel, cement, soap, water and a water proofing substance. The river gravel preferably includes natural stone, granite, limestone and domite. The cement is preferably off-white cement. The soap is preferably laundry detergent. The water proofing substance is preferably Grace Optec Admix waterproofing. The wet cast composition is preferably mixed in the following manner. The ground recycled glass, the river sand and the river gravel are mixed together to form an aggregate mix. The cement is combined with the aggregate mix to form a cement aggregate mix. Water is added to the cement aggregate mix to form a wet aggregate mix. Finally, the soap and the waterproofing substance are combined with the wet aggregate mix. A liquid colorant may be added with the soap and waterproofing. The wet cast composition is now ready to be poured into concrete block molds or poured as cast concrete.

Accordingly, it is an object of the present invention to provide a concrete wet cast composition, which is hydrophobic.

Finally, it is another object of the present invention to provide a concrete wet cast composition, which has the unexpected result of providing a more vibrant color than that of the prior art when a colorant is added to the mixture.

These and additional objects, advantages, features and benefits of the present invention will become apparent from the following specification.

### DETAILED DESCRIPTION OF THE PREFERRED EMBODIMENTS

The wet cast composition preferably includes ground recycled glass, river sand, river gravel, cement, soap, water and a water proofing substance. The river gravel preferably includes natural stone, granite, limestone and domite. However, other types of stone may also be used. The cement is preferably an off-white cement. The soap is preferably laundry detergent. The soap acts as a lubricant and adds needed air to the wet cast composition. The addition of soap is optional. The waterproofing substance is preferably Grace Optec Admix waterproofing. Applicant defines the following abbreviations as follows: kilograms (kg), milliliters (ml), millimeters (mm) and micrometers (um). A preferred range of weights of the components in the wet cast composition is ground recycled glass 100 kg-600 kg, cement 50 kg-300 kg, river gravel 50 kg-300 kg, river sand 75 kg-400 kg, water 15 liters-100 liters, water proofing 150 ml-1600 ml and soap 15 ml-200 ml.

The square screen size for river gravel is 5 mm-10 mm for concrete block and 5 mm-38 mm for cast concrete. The square screen size for ground recycled glass may range from 13.2 mm to 0.075 mm, or 4.75 mm to 0.075 mm. If the square screen size range is 13.2 mm to 0.075 mm, then the following preferable percentages of ground recycled glass are in effect about 9% of 13.2 mm; 9% of 9.5 mm; 9% of 6.7 mm; 9% of 4.75 mm; 8-9% of 2.36 mm; 7-8% of 1.18 mm; 5-7% of 0.6 mm; 4-5% of 0.425 mm; 2-4% of 0.3 mm; 1-2% of 0.15 mm; and 1% of 0.075 mm. If the square screen size range is 4.75 mm to 0.075 mm, then the following preferable percentages of ground recycled glass are in effect about 25% of 4.75 mm; 22-25% of 2.36 mm; 19-22% of 1.18 mm; 14-19% of 0.6 mm; 11-14% of 0.425 mm; 6-11% of 0.3 mm; 3-6% of 0.15 mm; and 3% of 0.075 mm.

The square screen size for river sand is 150 um-10 mm. The following weights of components are given by way of example and not by way of limitation. The following weights of components have been found to provide a satisfactory wet cast composition, cement 150 kg, river gravel 150 kg, river sand 200 kg, ground glass 300 kg, water 50 liters, water proofing 0.5 liter and soap 50 milliliters. The wet cast composition or mix includes percentages by weight of 15% cement, 15% river gravel, 21.8% river sand, 32.8% ground glass and 12.8% water.

The wet cast composition is preferably mixed in the following manner. The ground recycled glass, the river sand and the river gravel are mixed together to form an aggregate mix. The cement is combined with the aggregate mix to form a cement aggregate mix. A granular based colorant may be added to the cement aggregate mix at this step. Water is added to the cement aggregate mix to form a wet aggregate mix. If the colorant is liquid, the colorant is added with the water. Finally, the soap and the water proofing substance are combined with the wet aggregate mix. The wet cast composition is now ready to be poured into concrete block molds or poured as cast concrete.

A more preferable wet cast mix includes 15% cement, 3%-0% fly ash, 50%-60% glass, 10%-0% sand, about 20% stone and about 5% water. A low range includes 15%-18% cement, 3% fly ash, 50% glass, 10% sand, about 20% stone and about 5% water. A high range includes 18% cement, 60% glass, about 20% stone and about 5% water. All of the above percentages are by weight.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of preparing a wet cast ready mix composition for producing concrete blocks or wet cast concrete comprising the steps of:
providing ground recycled glass having a percentage by weight of 50% to 60%;
providing river sand;
mixing river gravel with said ground recycled glass and said river sand to form an aggregate mix;
mixing a cement having a percentage by weight of 15%-18% with said aggregate mix to form a cement aggregate mix; and
mixing water in said aggregate mix to form a wet aggregate mix.

2. The method of preparing a wet cast ready mix composition for producing concrete blocks or wet cast concrete of claim 1, further comprising the step of:
adding a granular based colorant to said cement aggregate mix.

3. The method of preparing a wet cast ready mix composition for producing concrete blocks or wet cast concrete of claim 1, further comprising the step of:
providing at least one of natural stone, granite, limestone and domite for said river gravel.

4. The method of preparing a wet cast ready mix composition for producing concrete blocks or wet cast concrete of claim 1, further comprising the step of:
providing off-white cement for said cement.

5. The method of preparing a wet cast ready mix composition for producing concrete blocks or wet cast concrete of claim 1, further comprising the step of:
pouring said wet cast ready mix composition into at least one of a concrete block mold or as cast concrete.

6. A method of preparing a wet cast ready mix composition for producing concrete blocks or wet cast concrete comprising the steps of:
providing ground recycled glass having a percentage by weight of 50% to 60%;
mixing river gravel with said ground recycled glass to form an aggregate mix;
mixing cement having a percentage by weight of 15%-18% with said aggregate mix to form a cement aggregate mix; and
mixing water in said aggregate mix to form a wet aggregate mix.

7. The method of preparing a wet cast ready mix composition for producing concrete blocks or wet cast concrete of claim 6, further comprising the step of:
adding a granular based colorant to said cement aggregate mix.

8. The method of preparing a wet cast ready mix composition for producing concrete blocks or wet cast concrete of claim 6, further comprising the step of:
providing at least one of natural stone, granite, limestone and domite for said river gravel.

9. The method of preparing a wet cast ready mix composition for producing concrete blocks or wet cast concrete of claim 6, further comprising the step of:
providing off-white cement for said cement.

10. The method of preparing a wet cast ready mix composition for producing concrete blocks or wet cast concrete of claim 6, further comprising the step of:
pouring said wet cast ready mix composition into at least one of a concrete block mold or as cast concrete.

11. The method of preparing a wet cast ready mix composition for producing concrete blocks or wet cast concrete of claim 6, further comprising the step of:
adding soap to said water proofing.

12. The method of preparing a wet cast ready mix composition for producing concrete blocks or wet cast concrete of claim 11, further comprising the step of:
providing laundry detergent for said soap.

13. A method of preparing a wet cast ready mix composition for producing concrete blocks or wet cast concrete comprising the steps of:
providing ground recycled glass having a particle size which—passes through a square screen of 4.75 mm, 2.36 mm, 1.18 mm, 0.6 mm and 0.425 mm, said ground recycled glass having a percentage by weight of 50% to 60%;
providing river sand;
mixing river gravel with said ground recycled glass and said river sand to form an aggregate mix;
mixing cement with said aggregate mix to form a cement aggregate mix; and
mixing water in said aggregate mix to form a wet aggregate mix.

14. The method of preparing a wet cast ready mix composition for producing concrete blocks or wet cast concrete of claim 13, further comprising the step of:
adding a granular based colorant to said cement aggregate mix.

15. The method of preparing a wet cast ready mix composition for producing concrete blocks or wet cast concrete of claim 13, further comprising the step of:
providing at least one of natural stone, granite, limestone and domite for said river gravel.

16. The method of preparing a wet cast ready mix composition for producing concrete blocks or wet cast concrete of claim 13, further comprising the step of:
providing off-white cement for said cement.

17. The method of preparing a wet cast ready mix composition for producing concrete blocks or wet cast concrete of claim 13, further comprising the step of:
pouring said wet cast ready mix composition into at least one of a concrete block mold or as cast concrete.

18. The method of preparing a wet cast ready mix composition for producing concrete blocks or wet cast concrete of claim 1, further comprising the step of:
providing said ground recycled glass with the additional particle sizes which pass through a square screen of 13.2 mm, 9.5 mm and 6.7 mm.

19. The method of preparing a wet cast ready mix composition for producing concrete blocks or wet cast concrete of claim 1, further comprising the step of:
providing said ground recycled glass with the additional particle sizes which pass through a square screen of 9.5 mm and 6.7 mm.

20. The method of preparing a wet cast ready mix composition for producing concrete blocks or wet cast concrete of claim 1, further comprising the step of:
providing said ground recycled glass with the additional particle size which passes through a square screen of 6.7 mm.
